(19) United States
(12) Patent Application Publication
(10) Pub. No.: US 2026/0200465 A1
(43) Pub. Date: Jul. 16, 2026

(54) PATH PLANNING DEVICE AND METHOD

(71) Applicant: Mitsubishi Electric Corporation, Tokyo (JP)

(72) Inventor: Takafumi KASUGA, Tokyo (JP)

(73) Assignee: Mitsubishi Electric Corporation, Tokyo (JP)

(21) Appl. No.: 19/563,583

(22) Filed: Mar. 11, 2026

Related U.S. Application Data
(63) Continuation of application No. PCT/JP2023/041903, filed on Nov. 22, 2023.

(51) Int. Cl. B60W 30/09

(52) U.S. Cl. CPC B60W 30/09; B60W 2720/125

(57) ABSTRACT

An object is to generate a movement path of a mobile object by using not only information acquired from a sensor but also information indicating a possibility of collision with an obstacle, so that the mobile object can avoid the obstacle in a natural manner in more situations. A movement state estimating unit to estimate a movement state of a mobile object using information acquired from a sensor, a collision risk determining unit to output determination information that is information indicating a determination result for the mobile object to avoid an obstacle based on the movement state and collision risk information that is information indicating a possibility of collision between the mobile object and the obstacle, and a path planning unit to generate a movement path of the mobile object based on the determination information are provided.

### CROSS REFERENCE TO RELATED APPLICATION

This application is a Continuation of PCT International Application No. PCT/JP2023/041903, filed on November 22, 2023, which is hereby expressly incorporated by reference into the present application.

### TECHNICAL FIELD

The present disclosure relates to a path planning device and method.

### BACKGROUND ART

There has been proposed a path planning device that generates a movement path of a mobile object for the purpose of autonomous movement of the mobile object such as an automobile, a ship, or an aircraft. The mobile object that autonomously moves detects an obstacle around the mobile object using a sensor. Then, when there is an obstacle that may collide with the mobile object on the movement path planned in advance, the path planning device changes the movement path, so that the mobile object avoids the obstacle.

For example, Patent Literature 1 discloses a method in which a mobile object avoids an obstacle in a natural manner by performing braking with a fine natural feeling based on detection reliability (length of time during which the same obstacle is detected) that is reliability of a detection result of the obstacle by a sensor.

### CITATION LIST

### PATENT LITERATURE

Patent Literature 1: JP 2012-183868 A

### SUMMARY OF INVENTION

### TECHNICAL PROBLEM

However, the conventional technique described in Patent Literature 1 has the following problems.

For example, in an environment where the detection sensitivity of the sensor decreases, such as at nighttime or in fog, the obstacle detection distance of the sensor becomes shorter. As the obstacle detection distance becomes shorter, the accuracy of the detection reliability decreases. Therefore, even when braking based on the detection reliability is performed, there is a limit to the extent to which the mobile object can avoid an obstacle in a natural manner.

The present disclosure has been made to solve the above problems, and an object of the present disclosure is to generate a movement path of a mobile object by using not only information acquired from a sensor but also information indicating a possibility of collision with an obstacle, so that the mobile object can avoid the obstacle in a natural manner in more situations.

### SOLUTION TO PROBLEM

A path planning device of the present disclosure includes:

movement state estimating circuitry to estimate a movement state of a mobile object using information acquired from a sensor;

collision risk determining circuitry to output determination information that is information indicating a determination result for the mobile object to avoid an obstacle based on the movement state and collision risk information that is information indicating a possibility of collision between the mobile object and the obstacle; and

path planning circuitry to generate a movement path of the mobile object in such a manner that an avoidance acceleration that occur when the mobile object avoids the obstacle does not exceed a certain value based on the determination information.

A path planning method of the present disclosure includes:

estimating a movement state of a mobile object using information acquired from a sensor;

outputting determination information that is information indicating a determination result for the mobile object to avoid an obstacle based on the movement state and collision risk information that is information indicating a possibility of collision between the mobile object and the obstacle; and

generating a movement path of the mobile object in such a manner that an avoidance acceleration that occur when the mobile object avoids the obstacle does not exceed a certain value based on the determination information.

### ADVANTAGEOUS EFFECTS OF INVENTION

According to the present disclosure, in many situations, a mobile object can avoid an obstacle in a natural manner.

### BRIEF DESCRIPTION OF DRAWINGS

FIG. 1 is a functional block diagram illustrating a configuration of a path planning device according to a first embodiment.

FIG. 2 is a diagram illustrating a hardware configuration of the path planning device according to the first embodiment.

FIGS. 3A and 3B are diagrams for describing a specific operation of a conventional path planning device.

FIGS. 4A to 4C are diagrams for describing a specific operation of the conventional path planning device.

FIGS. 5A to 5D are diagrams for describing a specific operation of path planning device according to the first embodiment.

FIGS. 6A to 6D are diagrams for describing a specific operation of the path planning device according to the first embodiment.

FIG. 7 is a flowchart illustrating an operation of the path planning device according to the first embodiment.

### DESCRIPTION OF EMBODIMENTS

Hereinafter, embodiments will be described with reference to the drawings. The following embodiments are merely examples, and various modifications can be made within the scope of the present invention. In the description and drawings of the embodiments, the same elements and corresponding elements are denoted by the same reference numerals. The description of elements denoted by the same reference numerals will be omitted or simplified as appropriate. In the following embodiments, “unit” may be appropriately read as “circuit”, “process”, “procedure”, or “processing”.

### First Embodiment

### Configuration description

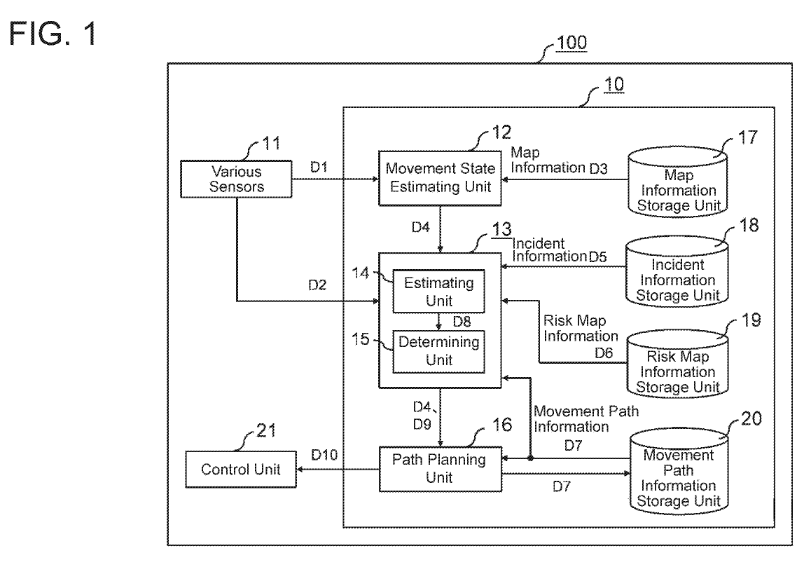

FIG. 1 is a functional block diagram illustrating a configuration of a path planning device according to the present embodiment. A path planning device 10 is a device that can implement a path planning method according to the embodiment. In FIG. 1, a mobile object 100 includes the path planning device 10, various sensors 11, and a control unit 21. The path planning device 10 includes a movement state estimating unit 12, a collision risk determining unit 13, a path planning unit 16, a map information storage unit 17, an incident information storage unit 18, a risk map information storage unit 19, and a movement path information storage unit 20. The collision risk determining unit 13 includes an estimating unit 14 and a determining unit 15.

The mobile object 100 is a mobile object capable of autonomously moving. For example, the mobile object 100 is an automated driving vehicle, a personal mobility, an autonomous traveling robot, a ship, a railway, an aircraft, a drone, or the like. Further, the mobile object 100 includes various sensors 11 necessary for autonomous movement. For example, the various sensors 11 are devices such as a global positioning system (GPS), an inertial measurement unit (IMU), a light detection and ranging (LiDAR), a millimeter-wave radar, an ultrasonic sensor, a camera, and a beacon. Note that the various sensors 11 may not include all these devices. The devices of the various sensors 11 may be appropriately selected or omitted according to the type of the mobile object 100, the moving environment, the device cost, and the like.

Note that the various sensors 11 are not necessarily provided in the mobile object 100. For example, a sensor (for example, a monitoring camera, a beacon, a roadside device, or the like) provided outside the mobile object 100 may acquire information necessary for autonomous movement of the mobile object 100. That is, as long as information necessary for the autonomous movement of the mobile object 100 can be provided to the mobile object 100 from the outside, the various sensors 11 of the mobile object 100 may be omitted.

The mobile object 100 includes a power source and a power device necessary for movement, and a driven device driven by the power device. For example, the power source is battery power, fuel, or the like. For example, the power device is a motor, an engine, or the like. For example, the driven device is a wheel, a propeller, a screw, or the like. The driven device may include a steering device for the mobile object 100 to perform direction change and braking. In FIG. 1, illustration of a power source, a power device, a driven device, and a steering device is omitted.

The various sensors 11 acquire mobile object information D1 indicating information on the state of the mobile object 100 itself. For example, the mobile object information D1 is information such as a moving speed, a moving direction, and a posture of the mobile object 100.

Further, the various sensors 11 acquire obstacle information D2 indicating information on an obstacle existing around the mobile object 100. For example, the obstacle information D2 is information such as a type, a position, a size, a shape, and a color of the obstacle, and whether or not the obstacle is moving. The obstacle is an object or a state that hinders the movement of the mobile object 100. For example, when the mobile object 100 is an automated driving vehicle, the obstacle is a falling object, a hole, a puddle, another mobile object, a person, an animal, or the like. For example, when the mobile object 100 is a ship, the obstacle is a stray object, a reef, an animal, another mobile object, or the like. For example, when the mobile object 100 is an aircraft, the obstacle is an air turbulence, a thundercloud, an animal, another mobile object, or the like. Note that the obstacle information D2 may be acquired by, for example, an external infrastructure device such as a roadside device, a monitoring camera, a beacon, or a radar, or various sensors included in another mobile object. The obstacle information D2 acquired by the external infrastructure device or another mobile object may be provided to the path planning device 10 of the mobile object 100 via a wireless communication device (not illustrated).

The map information storage unit 17 is a storage unit that stores map information D3 indicating the environment of the movement path of the mobile object 100. For example, the map information D3 can be information on a state of a ground or space including a road (pavement, unpaved, road inclination, or the like), or a railway track, a water channel, an intersection, a three-dimensional intersection, the number of lanes and the width of the lane, a road marking, or a sign and a traffic light. Note that the map information D3 may include information on the type, position, width, or size of a static feature that may hinder the movement of the mobile object 100.

The movement state estimating unit 12 estimates the movement state of the mobile object 100 using the mobile object information D1 and the map information D3. The estimated movement state is output as movement state information D4. For example, the movement state is a current position on the map, a speed, an acceleration, a moving direction, a posture, or the like of the mobile object 100.

The incident information storage unit 18 is a storage unit that stores incident information D5 indicating information on a situation in which an accident such as a collision, or a near-miss event (so-called close call) has occurred in the past. For example, the incident information D5 can be date and time when an accident has occurred, coordinates of a place, surrounding information of the place, weather, a type of a mobile object that has caused the accident, information regarding an obstacle, or the like. Note that the incident information D5 may be predetermined before the mobile object 100 moves, or may be changed in real time by an information update operation or the like from the outside of the mobile object 100 during the movement of the mobile object 100.

The risk map information storage unit 19 is a storage unit that stores risk map information D6 indicating information regarding a potential risk around the mobile object 100. More specifically, the risk map information D6 can be, for example, information in which the occurrence frequency of the risk that a collision between the mobile object and the obstacle may occur and the degree of influence of the risk are described on a map depending on the blind spot of the mobile object 100, the position of a feature around the mobile object 100, and the shape of the feature. Note that the risk map information D6 may be predetermined before the mobile object 100 moves, or may be changed in real time by an information update operation or the like from the outside of the mobile object 100 during the movement of the mobile object 100.

The movement path information storage unit 20 is a storage unit that stores movement path information D7 indicating information on the movement path including the moving speed and the moving direction of the mobile object 100. Note that the movement path information D7 may be determined in advance before the mobile object 100 moves, or may be appropriately changed by an information update operation or the like from the outside of the mobile object 100 during the movement of the mobile object 100.

The collision risk determining unit 13 estimates a collision risk between the mobile object 100 and the obstacle using the obstacle information D2, the movement state information D4, the incident information D5, the risk map information D6, and the movement path information D7, determines whether or not the mobile object 100 needs to avoid the obstacle, and outputs determination information D9 that is information indicating a determination result for the mobile object 100 to avoid the obstacle.

Next, an internal configuration of the collision risk determining unit 13 will be described.

The estimating unit 14 estimates collision risk information D8 indicating the possibility of collision with an obstacle when the mobile object 100 moves in accordance with the movement path information D7 using the obstacle information D2, the incident information D5, the risk map information D6, and the movement path information D7. More specifically, for example, the collision risk information D8 can be a numerical value indicating the probability of the mobile object 100 colliding with an obstacle at any position on the movement path indicated by the movement path information D7. For example, the collision risk information D8 may be expressed by a numerical value of a percentage from 0% to 100%. Alternatively, the collision risk information D8 may be expressed by a normalized numerical value from 0 to 1. For example, in a case where the collision risk information D8 is represented by a numerical value of a percentage, the larger the numerical value, the higher the risk of collision of the mobile object 100 with an obstacle.

The estimating unit 14 can estimate the collision risk information D8 using, for example, a trained model. When the obstacle information D2, the incident information D5, the risk map information D6, and the movement path information D7 are input to the trained model, the trained model outputs the collision risk information D8 that is a response to the input information. Note that, as a method of creating the trained model, for example, a method based on machine learning such as deep learning or a support vector machine can be used. In addition, the method of estimating the collision risk information D8 may be, for example, a rule-based method such as a method of referring to a predetermined table of a risk map.

Note that both the incident information D5 and the risk map information D6 are information indicating the possibility of collision with an obstacle (for example, another mobile object, a falling object, or the like) on the movement path. Therefore, the estimating unit 14 may estimate the collision risk information D8 using only the incident information D5. Alternatively, the estimating unit 14 may estimate the collision risk information D8 using only the risk map information D6.

The determining unit 15 determines whether or not the mobile object 100 needs to avoid the obstacle using the movement state information D4 and the collision risk information D8, and outputs the determination information D9 that is information indicating a determination result for the mobile object 100 to avoid the obstacle. More specifically, for example, the determining unit 15 can compare the collision risk information D8 at the position indicated by the movement state information D4 with a predetermined threshold, and output the determination information D9 in such a manner that the mobile object 100 starts an avoidance behavior in a case where the probability of collision is higher than the threshold.

The determining unit 15 can determine the congestion status around the mobile object 100 using the movement state information D4 and the collision risk information D8 in order to perform a safety check when changing course. For example, the congestion status is the number of mobile objects per predetermined distance around the movement path.

The determining unit 15 may determine not only whether or not the mobile object 100 avoids the obstacle but also whether or not to perform another operation. For example, the determining unit 15 may determine whether or not the mobile object 100 performs a preliminary operation which is a preparation for avoiding the obstacle. The preliminary operation indicates an operation of slowly decelerating the mobile object 100, such as lightly braking or stopping acceleration.

The determining unit 15 may determine whether or not the mobile object 100 performs an avoidance operation, such as a course change for the mobile object 100 to avoid the obstacle, a strong deceleration operation or a stop operation for the mobile object 100 to prevent collision with the obstacle. The avoidance operation indicates an operation of strongly decelerating the mobile object 100 to stop the mobile object, such as applying a normal brake, or an operation of changing the course of the mobile object 100.

Hereinafter, the configuration and operation of the path planning device 10 according to the present embodiment will be described in more detail, assuming that the mobile object 100 is an automated driving vehicle.

First, acceleration generated when the mobile object 100 decelerates or changes its course to avoid an obstacle will be described, and a movement path by which the mobile object 100 can avoid in a natural manner will be specifically defined.

First, for example, acceleration generated in the mobile object 100 by deceleration by a brake operation (deceleration) will be described. For example, when light braking is applied, the deceleration is approximately 0.1 G. Further, when normal braking is applied, the deceleration is about 0.2 G. Further, when the brake is applied strongly, the deceleration is about 0.3 G. Here, G is a unit representing gravitational acceleration. Generally, a person feels uncomfortable when the deceleration exceeds 0.3 G. Therefore, it is preferable that the deceleration does not exceed about 0.25 G in consideration of a margin.

Further, when the mobile object 100 changes a course to avoid an obstacle, acceleration in a lateral direction is generated in the mobile object 100. The strength of the lateral acceleration conforms to the numerical value of the deceleration described above. Hereinafter, the deceleration and the lateral acceleration are collectively referred to as an avoidance acceleration.

From the above, the movement path by which the mobile object 100 can avoid in a natural manner is a movement path including a deceleration operation or a course change to such an extent that the avoidance acceleration does not exceed about 0.25 G, or a deceleration operation and a course change. Note that the numerical value of 0.25 G of the avoidance acceleration is an example, and the numerical value of the avoidance acceleration may be appropriately changed depending on, for example, the type of the mobile object 100 and the attribute (driver, passenger, or the like) of the occupant riding on the mobile object 100.

As for a method of determining the possibility of collision with the obstacle using the collision risk information D8 and determining the operation of the mobile object 100 in the determining unit 15, for example, a rule-based method can be used. Hereinafter, a rule-based determination method will be described by exemplifying a case where the collision risk information D8 is expressed by a numerical value of a percentage from 0% to 100%.

First, the possibility of collision is determined, and a threshold for determining the operation of the mobile object 100 is defined. Predetermined thresholds determined in advance are set to TH1 and TH2, and for example, the values of the thresholds TH1 and TH2 are set to TH1 = 20% and TH2 = 80%, respectively. Note that the individual values of the threshold TH1 and the threshold TH2 are examples, and the values of the threshold TH1 and the threshold TH2 can be appropriately changed according to the distance from the mobile object 100 to the obstacle, the numerical value of the probability that the obstacle is present, the movement state of the mobile object 100, the situation of the movement path, or the like.

In a case where the collision risk information D8 is equal to or more than the threshold TH2, the determining unit 15 determines that the possibility of collision with the obstacle is high, and outputs the determination information D9 in such a manner that the mobile object 100 performs the main operation (braking or course change).

In a case where the collision risk information D8 is less than the threshold TH2 and equal to or greater than the threshold TH1, the determining unit 15 determines that the possibility of collision with the obstacle is medium, and outputs the determination information D9 in such a manner that the mobile object 100 performs the preliminary operation.

In a case where the collision risk information D8 is less than the threshold TH1, the determining unit 15 determines that the possibility of collision with the obstacle is low, and outputs the determination information D9 in such a manner that the mobile object 100 maintains the current course and speed.

Note that the predetermined threshold for determining the possibility of collision is not limited to two. For example, in a case where there is a plurality of types of preliminary operations (for example, the operations of lightly braking and stopping acceleration are divided), the predetermined threshold can be set to three or more levels.

Furthermore, the possibility of collision may be set as continuous values using, for example, a function y = f(x) having the collision risk information D8 as an input x and the possibility of collision as an output y. For example, the function f(x) can be obtained by a statistical method such as regression analysis using data of a past accident or near-miss event.

In addition, the determining unit 15 may determine the possibility of collision using the trained model. Specifically, when the collision risk information D8 is input to the trained model, the trained model infers the possibility of collision and determines the determination information D9. For example, machine learning such as deep learning or a support vector machine can be used to create the trained model.

The path planning unit 16 generates a movement path in which the mobile object 100 can avoid an obstacle in a natural manner using the movement state information D4, the movement path information D7, and the determination information D9. The generated (updated) movement path is re-output to the movement path information storage unit 20 as the movement path information D7 and is also output as control information D10.

The control unit 21 controls the power source, the power device, the driven device, and the steering device of the mobile object 100 using the control information D10. Then, the mobile object 100 can avoid the obstacle in a natural manner by moving along the generated movement path.

As described above, the collision risk determining unit 13 comprehensively determines the estimation of the collision risk between the mobile object 100 and the obstacle and the method by which the mobile object 100 avoids the obstacle not only by the information (that is, the obstacle information D2) acquired from the various sensors but also by using the information (that is, the incident information D5 and the risk map information D6) indicating the possibility of collision with the obstacle or another mobile object, and thus the mobile object 100 can avoid the obstacle in a natural manner.

### Description of hardware configuration

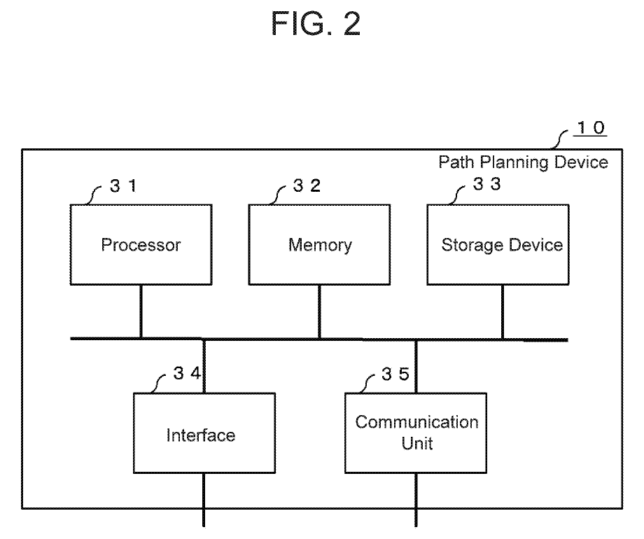

FIG. 2 is a diagram illustrating a hardware configuration of the path planning device 10 according to the present embodiment. The path planning device 10 is, for example, a computer, a dedicated arithmetic device, or a device obtained by combining a computer and a dedicated arithmetic device. The path planning device 10 includes a processor 31 that is an information processing unit, a memory 32 that is a storage unit, a storage device 33 that is a nonvolatile storage unit, an interface 34, and a communication unit 35.

The processor 31 is connected to other hardware via a system bus and controls the other hardware. The processor 31 is an integrated circuit (IC) that performs processing. A specific example of the processor 31 is a central processing unit (CPU), a digital signal processor (DSP), a graphics processing unit (GPU), or a field programmable gate array (FPGA).

The processor 31 executes a program stored in the memory 32. The program includes the path planning program according to the present embodiment. The function of the path planning device 10 is implemented by the processor 31 that executes a program. The processor 31 is an example of processing circuitry (processing circuit).

For example, the movement state estimating unit 12, the collision risk determining unit 13, and the path planning unit 16 are implemented by the processor 31. For example, the map information storage unit 17, the incident information storage unit 18, the risk map information storage unit 19, and the movement path information storage unit 20 are implemented by the memory 32.

The CPU performs processing such as execution of a program and data calculation. The DSP performs digital signal processing such as arithmetic operation and data movement. For example, processing such as sensing of sensor data obtained from a millimeter-wave radar is desirably processed at high speed by a DSP instead of processing by a CPU.

The GPU is a processor specialized for image processing. The GPU can perform high-speed image processing by processing a plurality of pieces of pixel data in parallel. The GPU can quickly perform template matching processing frequently used in image processing. For example, sensing of sensor data obtained from a camera is desirably processed by a GPU. When the sensing of the sensor data obtained from the camera is processed by the CPU, processing time is enormous. Further, the GPU is used not only as a processor for simple image processing but also for performing general-purpose calculation using the calculation resources of the GPU (General Purpose Computing on Graphics Processing Units (GPGPU)). For example, by performing image processing by deep learning using the GPGPU, it is possible to detect an obstacle, another mobile object, or the like with higher accuracy.

The FPGA is a processor capable of programming a configuration of a logic circuit. The FPGA has properties of both a dedicated hardware arithmetic circuit and programmable software. Complex operations and parallel processing can be performed at high speed by the FPGA.

The memory 32 is, for example, a volatile memory. The volatile memory is capable of moving data at a high speed during operation of the path planning device 10. For example, a specific example of the volatile memory is a random access memory (RAM), a synchronous dynamic random access memory (SDRAM), or the like.

The storage device 33 is a nonvolatile memory, and can keep holding the execution program and data even while the power supply of the path planning device 10 is off. Specific examples of the nonvolatile memory include an electrically erasable programmable read only memory (EEPROM), a hard disk drive (HDD), a solid state drive (SSD), and a flash memory. For example, the nonvolatile memory may be a portable storage medium such as a secure digital (SD) (registered trademark) memory card, a CompactFlash (CF) (registered trademark), a NAND flash, a flexible disk, an optical disk, a compact disk, a Blu-ray (registered trademark) disk, or a digital versatile disc (DVD).

In addition, the path planning program according to the present embodiment may be provided by a portable recording medium. The memory 32 is connected to the processor 31 via a memory interface (not illustrated). The memory interface centrally manages memory accesses from the processor and performs efficient memory access control. The memory interface is used for data transfer in the path planning device 10.

The functions of the movement state estimating unit 12, the collision risk determining unit 13, and the path planning unit 16 illustrated in FIG. 1 are implemented by the processor 31 that executes a program. The memory 32 stores programs for implementing the functions of the movement state estimating unit 12, the collision risk determining unit 13, and the path planning unit 16. The processor 31 reads these programs from the memory 32 and executes these programs. Further, the memory 32 is also used to temporarily store intermediate information of each program.

In addition, the functions of the movement state estimating unit 12, the collision risk determining unit 13, and the path planning unit 16 may be implemented by a logic circuit which is hardware. In this case, logic circuit information is stored in the memory 32. The logic circuit information is read and executed by the processor 31.

The processor 31 may also be configured by a plurality of processors. In this case, a plurality of processors may cooperatively execute programs for implementing the functions of the movement state estimating unit 12, the collision risk determining unit 13, and the path planning unit 16.

The memory 32 stores the map information D3, the incident information D5, the risk map information D6, and the movement path information D7. Note that the map information D3, the incident information D5, the risk map information D6, and the movement path information D7 may be stored in a storage device outside the path planning device 10. In other words, the map information storage unit 17, the incident information storage unit 18, the risk map information storage unit 19, and the movement path information storage unit 20 may be storage devices outside the path planning device 10.

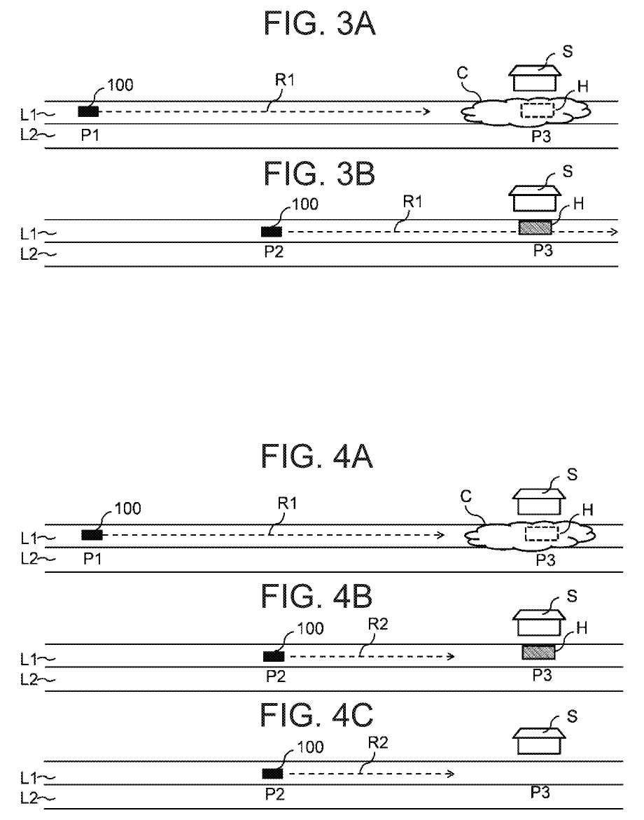

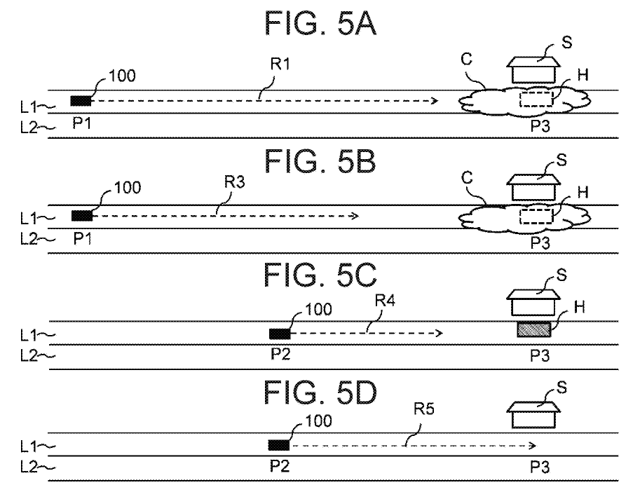

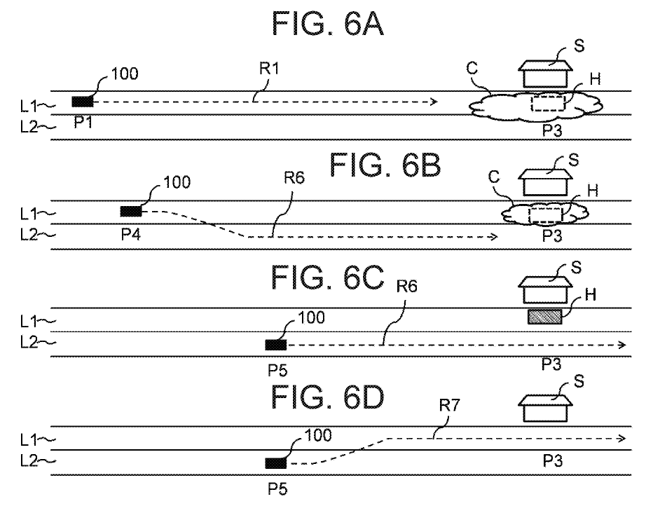

The operation and effect of the path planning device 10 according to the present embodiment will be described by comparing with the operation of a conventional path planning device. FIGS. 3 and 4 are diagrams for describing a specific operation of the conventional path planning device. FIGS. 5 and 6 are diagrams for describing a specific operation of the path planning device 10 according to the present embodiment. In each of FIGS. 3 to 6, for example, an environment (weather) in which the detection sensitivity of the sensor decreases will be described as fog, but the environment is not limited to fog. For example, the environment in which the detection sensitivity of the sensor decreases may include various cases such as rain, snow, nighttime, smoke due to fire or eruption, smog, dust, and the like.

First, a specific operation of the conventional path planning device will be described with reference to FIG. 3. In FIG. 3A, the mobile object 100 moves on a lane L1 and is located at a point P1. Further, a store S is present beside the road of the lane L1 at a point P3. In the obstacle information D2 acquired by the mobile object 100 at the point P1, there is a possibility that an obstacle H (for example, a parked vehicle) exists at the point P3, which is 100 to 120 meters away from the mobile object 100, and the detection reliability of the obstacle H is 60%. The cloud-like symbol C drawn to surround the obstacle H simulatively expresses the detection reliability of the obstacle, and expresses that the larger the cloud-like symbol C, the lower the detection reliability. A dotted arrow R1 coming out from the mobile object 100 indicates a movement path on which the mobile object 100 is scheduled to move within a certain period of time from the current time. Further, the length of the arrow is proportional to the speed of the mobile object 100.

In FIG. 3A, the conventional path planning device estimates that there is a possibility that the obstacle H exists in the vicinity of the point P3 at the position of the point P1, but determines that the conventional path planning device does not perform any obstacle avoidance operation because the detection reliability is low.

In FIG. 3B, the mobile object 100 moves in the direction of the arrow R1 from the point P1 illustrated in FIG. 3A and is located at a point P2. Further, the obstacle information D2 acquired by the mobile object 100 at the time point when the mobile object reaches the position of the point P2 has a possibility that the obstacle H exists at a point which is 50 meters away from the mobile object 100, and the detection reliability is 99%. In FIG. 3B, since the mobile object 100 does not take an avoidance behavior while moving from the point P1 to the point P2, the speed of the mobile object 100 at the point P2 is the same as the speed at the point P1. Thus, it is ensured that the mobile object 100 needs avoidance at the position of the point P2. Therefore, the mobile object 100 needs to be braked. However, since the distance to the obstacle H is short, the mobile object 100 has to perform sudden braking or sudden course change.

Therefore, the mobile object 100 cannot avoid the obstacle H in a natural manner.

FIG. 4 is another example of the operation of the conventional path planning device. In FIG. 4A, the mobile object 100 is located at the point P1 on the lane L1, similarly to FIG. 3A. Further, in the obstacle information D2 acquired by the mobile object 100 at the position of the point P1, there is a possibility that the obstacle H exists at the point P3, which is 100 to 120 meters away from the mobile object 100, and the detection reliability thereof is 60%. The difference from the case illustrated in FIG. 3 is that, in the case of FIG. 4, although the detection reliability is low at the point P1, the determination to avoid the obstacle H by stopping is made.

FIG. 4B illustrates a case where the obstacle H is almost certainly present (for example, the detection reliability is 99% or more) at the time point when the mobile object 100 arrives at the point P2. In this case, since the mobile object 100 has decelerated in advance in preparation for stopping, the mobile object can stop before reaching the obstacle H.

On the other hand, FIG. 4C illustrates a case where the obstacle H is not present when the mobile object 100 arrives at the point P2. In this case, the mobile object 100 performs unnecessary deceleration. Further, the deceleration of the mobile object 100 is performed in anticipation of stopping, and thus the speed of the mobile object 100 is significantly reduced. In order to quickly return the speed of the mobile object 100 to the original speed, it is necessary to re-accelerate the mobile object 100, but the resulting acceleration becomes abrupt.

Also in this case, the mobile object 100 cannot avoid the obstacle H in a natural manner.

Next, an operation of the path planning device 10 according to the present embodiment will be described. FIGS. 5 and 6 are diagrams for describing a specific operation of the path planning device 10 according to the present embodiment.

In FIG. 5A, the mobile object 100 is located at the point P1 as in FIG. 3A. Further, a store S is present beside the road of the lane L1 at the point P3. In the obstacle information D2 acquired by the mobile object 100 at the point P1, there is a possibility that the obstacle H exists at the point P3, which is 100 to 120 meters away from the mobile object 100, and the detection reliability of the obstacle H is 60%. The cloud-like symbol C drawn to surround the obstacle H simulatively expresses the detection reliability of the obstacle, and expresses that the larger the cloud-like symbol C, the lower the detection reliability.

In FIG. 5A, the collision risk determining unit 13 estimates the collision risk between the mobile object 100 and the obstacle H at the point P1 using the obstacle information D2, the movement state information D4, the incident information D5, the risk map information D6, and the movement path information D7. Then, the collision risk determining unit 13 determines whether or not the mobile object 100 needs to avoid the obstacle and the contents of the preliminary operation or the main operation based on the estimated collision risk.

In the case of FIG. 5A, as a result of the estimating unit 14 referring to the incident information D5 and the risk map information D6, it has been confirmed that there is the store S along the road in the vicinity of the point P3. Then, it has been confirmed that several rear-end collisions have occurred in the past since vehicles (that is, the obstacle H) for cargo loading and unloading frequently stop on the road in front of the store S. From these results, the estimating unit 14 estimates that the collision risk in the vicinity of the point P3 is medium.

At the position of the point P1, the probability (detection reliability) that the obstacle H is present is medium at 60%, and whether or not the mobile object 100 always stops is in an undetermined state. However, as illustrated in FIG. 5B, the collision risk determining unit 13 prepares for a case where it is determined that it is highly necessary to stop the mobile object 100 because the collision risk is medium. That is, the collision risk determining unit 13 determines that it is necessary to apply light braking (that is, the preliminary operation) in advance in such a manner that the mobile object 100 can stop with sufficient safety margin. Then, the path planning unit 16 generates a path for decelerating the moving speed of the mobile object 100 as indicated by an arrow R3 according to the determination information D9.

Subsequently, FIG. 5C illustrates a case where it is almost confirmed that the obstacle H is present as the mobile object 100 has moved to the point P2. In this case, the collision risk determining unit 13 determines that it is necessary to stop before the obstacle H. Then, the path planning unit 16 further changes the movement path as indicated by an arrow R4 according to the determination information D9 in order to stop the mobile object 100 before reaching the obstacle H. In other words, the path planning unit 16 further decelerates the mobile object 100 than the speed indicated by the movement path of the arrow R4 and stops the mobile object before the obstacle H. By gradually decreasing the speed of the mobile object 100, the deceleration of the mobile object 100 until reaching the obstacle H is gentle.

Therefore, the mobile object 100 can avoid (stop) the obstacle H in a natural manner.

FIG. 5D illustrates an example in which it is determined that there is no obstacle H as the mobile object 100 has moved to the point P2. In this case, the collision risk determining unit 13 determines the end of the preliminary operation for avoidance. Then, the path planning unit 16 generates a movement path in which the mobile object accelerates in such a manner that the mobile object 100 returns to the speed defined by the movement path.

In this case, since the mobile object 100 is only performing the minimum deceleration, it is possible to return to the original speed by slight re-acceleration. Therefore, the mobile object 100 can avoid the obstacle H in a natural manner.

Next, another example will be described with reference to FIG. 6. The example illustrated in FIG. 6 illustrates a case where the collision risk determining unit 13, as a result of considering the distance to the obstacle H, the detection reliability, the traveling speed of the mobile object 100, and the like, recognizes a possibility that the obstacle H exists but suspends the determination until the distance to the obstacle H becomes slightly shorter.

In FIG. 6A, the mobile object 100 is located at the point P1 as in FIG. 5A. Further, a store S is present beside the road of the lane L1 at the point P3. In the obstacle information D2 acquired by the mobile object 100 at the point P1, there is a possibility that the obstacle H exists at the point P3, which is 100 to 120 meters away from the mobile object 100, and the detection reliability of the obstacle H is 60%. The cloud-like symbol C drawn to surround the obstacle H simulatively expresses the detection reliability of the obstacle, and expresses that the larger the cloud-like symbol C, the lower the detection reliability.

FIG. 6B illustrates a case where the mobile object 100 moves to the point P4, the distance to the obstacle H is short, and the detection reliability increases from 60% to 75%. At this point, the collision risk determining unit 13 determines that the preliminary operation for avoiding the obstacle is necessary. Subsequently, the collision risk determining unit 13 determines a congestion status (that is, the possibility of collision with another mobile object) around the mobile object 100 using the movement state information D4, the incident information D5, the risk map information D6, and the movement path information D7.

In FIG. 6B, since there is no other mobile object around the mobile object 100, the collision risk determining unit 13 determines that the congestion degree of the other mobile object existing around the mobile object is low. Then, unlike the example of FIG. 5 described above, the collision risk determining unit 13 determines to avoid the obstacle by changing the movement path instead of stopping the mobile object 100. In accordance with the determination information D9 of the collision risk determining unit 13, the path planning unit 16 generates a movement path indicated by an arrow R6 in such a manner that the mobile object 100 changes its course to the adjacent lane L2.

FIG. 6C illustrates a case where the mobile object 100 has moved to the point P5 and the presence of the obstacle H is almost confirmed. In this case, since the mobile object 100 has already changed the course to the adjacent lane L2, the mobile object continues to move and passes by the obstacle H.

FIG. 6D illustrates a case where there is no obstacle H. In this case, the collision risk determining unit 13 determines to end the avoidance operation. Then, as indicated by an arrow R7, the path planning unit 16 generates a path returning to the movement path before the change.

As described above, the path planning device 10 selects the avoidance means in consideration of the surrounding situation of the mobile object 100, and when the obstacle H exists, the path planning device can avoid the obstacle H by changing the position to be moved, and when the obstacle H does not exist, the path planning device can quickly return to the original (before change) scheduled movement path without blocking the movement of the surrounding mobile object. Therefore, the mobile object 100 can avoid the obstacle H in a natural manner.

In the examples of FIGS. 5 and 6, the collision risk information D8, which is information indicating the possibility of collision between the mobile object 100 and the obstacle H, is a collision risk estimated from that several rear-end collisions have occurred in the past due to frequent stop of vehicles for cargo loading and unloading on the road in front of the store S near the point P3. The collision risk determining unit 13 outputs the determination information D9 that is information indicating a determination result for the mobile object 100 to avoid the obstacle H based on the movement state of the mobile object 100 and the collision risk information D8. Then, the path planning unit 16 can generate the movement path of the mobile object 100 based on the determination information D9. Therefore, the mobile object 100 can avoid the obstacle H in a natural manner.

As described above, in the path planning device 10 according to the present embodiment, the collision risk determining unit 13 comprehensively determines the possibility of collision with an obstacle or another mobile object by using the information (that is, the incident information D5 and the risk map information D6) indicating the possibility of collision with the obstacle or another mobile object without depending only on the information (that is, obstacle information D2) acquired from various sensors, and thus, when there is a possibility that the obstacle H is present, it is possible to cause the mobile object 100 to perform the minimum necessary preliminary operation. As a result, the mobile object 100 can reliably avoid the obstacle H or reliably stop in a natural manner. Further, the path planning device 10 according to the present embodiment can quickly return the mobile object 100 to the speed defined by the movement path only after the minimum deceleration even when the obstacle H does not exist.

Therefore, the path planning device 10 according to the present embodiment enables the mobile object 100 to avoid obstacles in a natural manner in various situations.

### Description of operation order

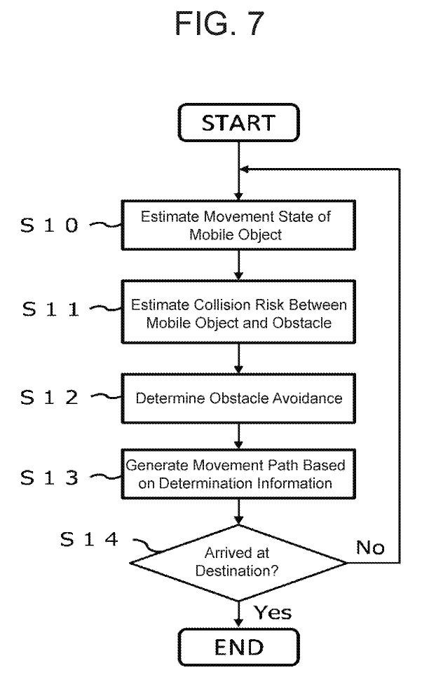

Next, an operation order of the path planning device 10 according to the present embodiment will be described. FIG. 7 is a flowchart illustrating the operation of the path planning device 10.

In step ST10, the movement state estimating unit 12 estimates the movement state of the mobile object 100 using the mobile object information D1 and the map information D3 (step ST10).

In step ST11, the estimating unit 14 estimates the collision risk information D8 indicating the possibility of collision with an obstacle when the mobile object 100 moves in accordance with the movement path information D7 using the obstacle information D2, the incident information D5, the risk map information D6, and the movement path information D7 (step ST11).

In step ST12, the determining unit 15 determines whether or not the mobile object 100 needs to avoid the obstacle using the movement state information D4 and the collision risk information D8, and outputs the determination information D9 indicating an avoidance determination result (step ST12).

In step ST13, the path planning unit 16 generates the movement path information D7 based on the determination information D9 using the movement state information D4, the movement path information D7, and the determination information D9 (step ST13). Specifically, the path planning unit 16 generates, based on the determination information D9, a movement path on which a preliminary operation for the mobile object 100 to avoid the obstacle, for example, light braking (deceleration) is performed, a movement path on which a main operation for the mobile object 100 to avoid the obstacle, for example, braking (deceleration) or course change is performed, or a movement path on which the mobile object 100 maintains the current course and moving speed.

In step ST14, it is determined whether or not the mobile object 100 has arrived at the destination. When the mobile object 100 arrives at the destination (Yes in step ST14), the processing flow ends. When it has not arrived (No in step ST14), the process again proceeds to step ST10. Then, the estimation of the movement state of the mobile object 100, the estimation of the collision risk with the obstacle, the output of the determination information D9, and the planning of the movement path of the mobile object 100 described above are executed.

### Effects of First Embodiment

As described above, in the path planning device according to the present embodiment, the collision risk determining unit 13 comprehensively determines the estimation of the collision risk between the mobile object 100 and the obstacle and the method by which the mobile object 100 avoids the obstacle not only by using the information (that is, the obstacle information D2) acquired from the various sensors 11 but also by using the information (that is, the incident information D5 and the risk map information D6) indicating the possibility of collision with the obstacle or another mobile object, and outputs the determination information D9. Then, the path planning unit 16 generates a movement path based on the determination information D9.

As a result, the mobile object 100 can quickly determine the possibility of collision with an obstacle, and can move along a movement path on which an appropriate avoidance operation is performed. Therefore, the mobile object 100 can avoid the obstacle in a natural manner.

In the above-described embodiment, the automated driving vehicle has been described as an example of the mobile object, but the mobile object is not limited to the automated driving vehicle. For example, the mobile object may be a railway, a ship, an aircraft, or the like. For example, when the mobile object is a railway, the path planning device according to the present disclosure can generate a movement path by regarding the track as the movement path. Furthermore, for example, in a case where the mobile object is a ship, the path planning device according to the present disclosure can generate a movement path by regarding the water channel or the path as the movement path.

### INDUSTRIAL APPLICABILITY

The path planning device according to the present disclosure is applicable to various mobile objects such as an automobile, a personal mobility, a railway, a ship, an aircraft, and a drone. In particular, the path planning device according to the present disclosure is suitable for use in an automated driving vehicle that autonomously moves.

### REFERENCE SIGNS LIST

10: path planning device, 11: various sensors, 12: movement state estimating unit, 13: collision risk determining unit, 14: estimating unit, 15: determining unit, 16: path planning unit, 17: map information storage unit, 18: incident information storage unit, 19: risk map information storage unit, 20: movement path information storage unit, 21: control unit, 31: processor, 32: memory, 33: storage device, 34: interface, 35: communication unit, 100: mobile object

1. A path planning device comprising:
movement state estimating circuitry to estimate a movement state of a mobile object using information acquired from a sensor;
collision risk determining circuitry to output determination information that is information indicating a determination result for the mobile object to avoid an obstacle based on the movement state and collision risk information that is information indicating a possibility of collision between the mobile object and the obstacle; and
path planning circuitry to generate a movement path of the mobile object in such a manner that an avoidance acceleration that occur when the mobile object avoids the obstacle does not exceed a certain value based on the determination information.

2. The path planning device according to claim 1, wherein
the certain value is a value obtained by subtracting 0.05 G being a margin from an acceleration at which an occupant riding on the mobile object feels uncomfortable.

3. The path planning device according to claim 1, wherein
the collision risk determining circuitry determines a preliminary operation or an avoidance operation for the mobile object to avoid the obstacle based on the movement state and the collision risk information, and
the path planning circuitry generates a movement path based on the preliminary operation or the avoidance operation.

4. The path planning device according to claim 1, wherein
the collision risk information includes at least one of incident information indicating information on a situation where a past accident or a near-miss event has occurred or risk map information indicating information regarding a potential risk around the mobile object.

5. A path planning method comprising:
estimating a movement state of a mobile object using information acquired from a sensor;
outputting determination information that is information indicating a determination result for the mobile object to avoid an obstacle based on the movement state and collision risk information that is information indicating a possibility of collision between the mobile object and the obstacle; and
generating a movement path of the mobile object in such a manner that an avoidance acceleration that occur when the mobile object avoids the obstacle does not exceed a certain value based on the determination information.
